(19) United States
(12) Patent Application Publication
(10) Pub. No.: US 2023/0123921 A1
(43) Pub. Date: Apr. 20, 2023

(54) FACILITATING THE EMBEDDING OF BLOCK REFERENCES FOR REDUCING FILE ACCESS LATENCY FILE SYSTEMS

(71) Applicant: EMC IP Holding Company LLC, Hopkinton, MA (US)

(72) Inventor: Anton Rang, Houlton, WI (US)

(21) Appl. No.: 17/501,283

(22) Filed: Oct. 14, 2021

(51) Int. Cl. G06F 16/22; G06F 16/18; G06F 16/17

(52) U.S. Cl. CPC G06F 16/2246; G06F 16/1858; G06F 16/1727

(57) ABSTRACT

Facilitating the embedding of block references for reducing and/or mitigating file access latency in file systems is provided herein. A system includes a processor and a memory that stores executable instructions that, when executed by the processor, facilitate performance of operations. The operations include populating a data structure of the system with information indicative of a block pointer that identifies a first location of a first data block of an object. The first location is a location within a storage system. The operations also can include, based on a receipt of a read request for the object, enabling access to the first data block of the object based on the block pointer. Enabling access can include bypassing a reading of a block map for access to the first data block.

### BACKGROUND

Storage systems and/or object storage systems can provide a wide range of storage services while achieving high scalability, availability, and serviceability. Operations of storage systems and/or object storage systems can include a file retrieval system. In order to retrieve the file, the location of one or more initial data blocks of the file have to be located, by reading an entire map tree, which introduces latency during the retrieval.

The above-described context with respect to conventional storage systems is merely intended to provide an overview of current technology and is not intended to be exhaustive. Other contextual description, and corresponding benefits of some of the various non-limiting embodiments described herein, will become further apparent upon review of the following detailed description.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an embodiment, provided herein is a system that includes a processor and a memory that stores executable instructions that, when executed by the processor, facilitate performance of operations. The operations can include populating a data structure of the system with information indicative of a block pointer that identifies a first location of a first data block of an object. The first location is a location within a storage system. The operations also can include, based on a receipt of a read request for the object, enabling access to the first data block of the object based on the block pointer. Enabling access can include bypassing a reading of a block map for access to the first data block.

According to some implementations, the operations can include facilitating reading the block map for access to a second data block of the object at a same time or substantially the same time as the accessing the first data block. The storage system can be a geographically distributed object storage system. Further, the object can be a file stored on a file system.

In an example, the information indicative of the block pointer is a copy of the first data block from the block map. In another example, the information indicative of the block pointer includes a group of data blocks, including the first data block, from the block map. According to another example, the information indicative of the block pointer includes respective checksums associated with data blocks of the group of data blocks.

In some implementations, the information indicative of the block pointer is first information and the operations further include determining a first amount of space in the data structure reserved for an embedded tree data structure, and a second amount of space in the data structure consumed by the first information, resulting in a defined amount of conserved space. Further to these implementations, the operations include repurposing the defined amount of conserved space for second information other than the block map for the embedded tree data structure.

Bypassing the reading of the block map can include, according to some implementations, reducing an amount of latency for reading the object as compared to traversing the block map in order to derive the first location of the first data block. Further to these implementations, reducing the amount of latency can include reading the first data block of the object in a single read access, as compared to multiple read accesses for traversing the block map.

Another embodiment relates to a method that can include embedding, by a system including a processor, information from a block map into a data structure. The information can include instructions to read first data of a file. The method also can include, in response to a read request for the file from a node device, returning, by the system, the information to the node device. Returning the information can include facilitating, by the system, implementation of a prefetch operation for the first data of the file that executes in parallel with determining instructions for reading second data of the file.

According to some implementations, facilitating the implementation of the prefetch operation can include causing the node device to bypass traversal of a tree chain before retrieving the first data of the file. In some implementations, facilitating the implementation of the prefetch operation can include streaming the first data of the file without incurring a delay associated with data mining the block map for the information. In yet other implementations, facilitating the implementation of the prefetch operation can include instructing the node device to perform a set of reads including a first read to the data structure and a second read to the first data of the file.

In some implementations, the information from the block map is first information and the method can include determining, by the system, a first amount of data structure memory reserved for an embedded tree data structure, and a second amount of data structure memory consumed by the first information, resulting in a defined amount of conserved memory. Further to these implementations, the method can include repurposing, by the system, the defined amount of conserved memory for second information other than the block map for the embedded tree data structure.

The first data of the file is located at a beginning of the file, and the second data of the file is subsequent data of the file. The node device can be a network node device of a cluster of network node devices that are part of a file system.

Another embodiment relates to a non-transitory machine-readable medium, including executable instructions that, when executed by a processor, facilitate performance of operations. The operations can include sending a first request to read an object and receiving, in response to the first request, information indicative of a first node address for first data of the object. The operations can also include performing parallel operations which can include performing a first operation that includes obtaining the first data of the object and a second operation that includes determining a second node address for second data of the object. Determining the second node address can include traversing a map tree for the second node address.

The parallel operations mitigate and/or reduce an amount of latency for reading the first data of the object as compared to traversing the map tree in order to derive a first location of a first data block of the object. Further, the first data of the object is data related to the beginning of the object, and wherein the second data is subsequent data of the object.

To the accomplishment of the foregoing and related ends, the disclosed subject matter includes one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example cluster of computing devices, in accordance with one or more embodiments described herein;

FIG. 2 illustrates an example of the multi-step process to find data for a file using a tree structure;

FIG. 3 illustrates an example, non-limiting, schematic representation of a tree structure wherein one or more block addresses are embedded in the inode in accordance with one or more embodiments described herein;

FIG. 4 illustrates an example, non-limiting, system that facilitates embedding block references for reducing file access latency in file systems in accordance with one or more embodiments described herein;

FIG. 5 illustrates an example, non-limiting, system that facilitates performing parallel processing to reduce file access latency in accordance with one or more embodiments described herein;

FIG. 6 illustrates a flow diagram of an example, non-limiting, computer-implemented method that facilitates mitigation of file access latency in accordance with one or more embodiments described herein;

FIG. 7 illustrates a flow diagram of an example, non-limiting, computer-implemented method that reuses space originally reserved for an embedded tree data structure in accordance with one or more embodiments described herein;

FIG. 8 illustrates a flow diagram of an example, non-limiting, computer-implemented method that performs parallel processing to reduce file access latency devices in accordance with one or more embodiments described herein;

FIG. 9 illustrates an example, non-limiting, computing environment in which one or more embodiments described herein can be facilitated; and

FIG. 10 illustrates an example, non-limiting, networking environment in which one or more embodiments described herein can be facilitated.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

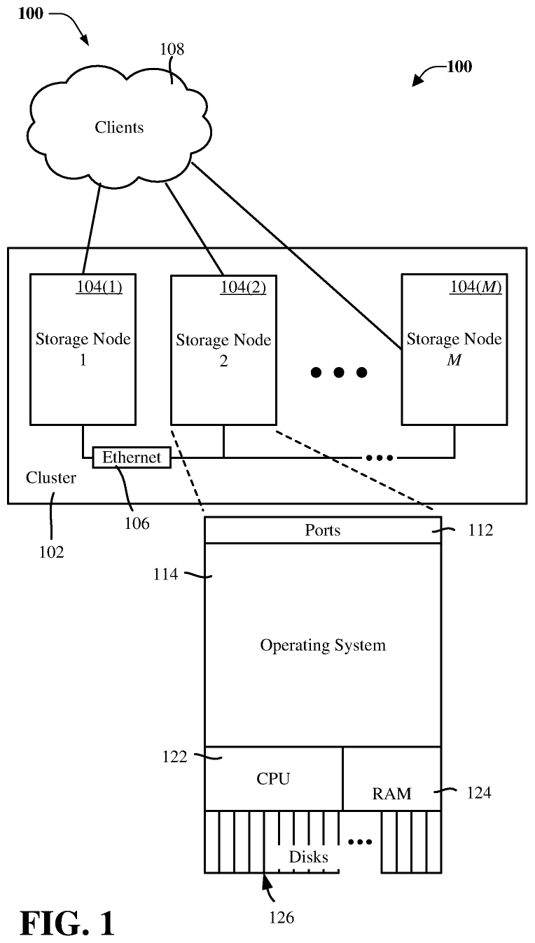

FIG. 1 illustrates an example cluster of computing devices, in accordance with one or more embodiments described herein. FIG. 1 includes a cluster 102 of data node devices, referred to in FIG. 1 as storage nodes 104(1), 104(2) . . . 104(M), where M is a positive integer. Each storage node 104(1), 104(2) . . . 104(M) can comprise a computing device. Storage nodes 104(1), 104(2) . . . 104(M) can be configured to serve objects in response to requests from clients 108. Furthermore, typically one of the storage nodes 104(1), 104(2) . . . 104(M) can host a cluster controller virtual machine (not shown in FIG. 1), making that node the cluster controller node which administers the cluster 102. The storage nodes 104(1), 104(2) . . . 104(M) can be coupled to one other via a suitable data communications link comprising interfaces and protocols such as, but not limited to, Ethernet block 106.

Clients 108 can send data system-related requests to the cluster 102, which in general can be configured as one large object namespace. The cluster 102 can maintain an unlimited number of objects (e.g., up to trillions of objects or more). To this end, a node such as the node 104(2) generally comprises ports 112 by which clients 108 connect to the cluster 102. Example ports 112 are provided for requests via various protocols, including but not limited to SMB (Server Message Block), FTP (File Transfer Protocol), HTTP/HTTPS (Hypertext Transfer Protocol), and NFS (Network File System); further, SSH (Secure Shell) allows administration-related requests, for example.

Each node, such as the node 104(2), can include an instance of an operating system 114 (e.g., a OneFS®, PowerScale®, or other operating system). One example computing platform that can optionally incorporate the embedded block address techniques disclosed herein is an ISILON OneFS® cluster provided by DELL®, Inc. or a PowerScale® file system provided by DELL®, Inc. It can be appreciated that OneFS® clusters and/or PowerScale® file system are two of many optional cluster computing technologies, any of which can incorporate the teachings of this disclosure.

Each node, such as the node 104(2), can furthermore include a CPU 122, RAM 124, and storage devices such as disks 126. RAM 124 and disks 126 can comprise, for example, volatile memory, nonvolatile memory, hard disk drives, solid-state drives or other types of memory devices. Furthermore, RAM 124 and disks 126 at multiple of the storage nodes 104(1)-104(M), as well as other storage devices attached to the cluster 102, can be used to collectively support a logical disk which provides a shared storage location for the cluster 102.

It is noted that cluster deployments can be of any size. Depending on the needs of a particular organization, some clusters can comprise five or fewer nodes, while large clusters can comprise much larger numbers of nodes. The technologies disclosed herein can be included in clusters of any size.

The subject disclosure relates generally to file systems. More specifically, the subject disclosure relates to accessing files in file systems. Example embodiments are directed to facilitating the embedding of block references for mitigating and/or reducing file access latency in a file system. Some existing file systems use a tree structure (e.g., a B+ tree structure) to describe where the data for an object (e.g., a file, a photograph, thumbnails of photographs, and so on) can be found on disk (e.g., storage device, storage location, and so on). When a file is read from its beginning, the system goes through a multi-step process to find the data for the file.

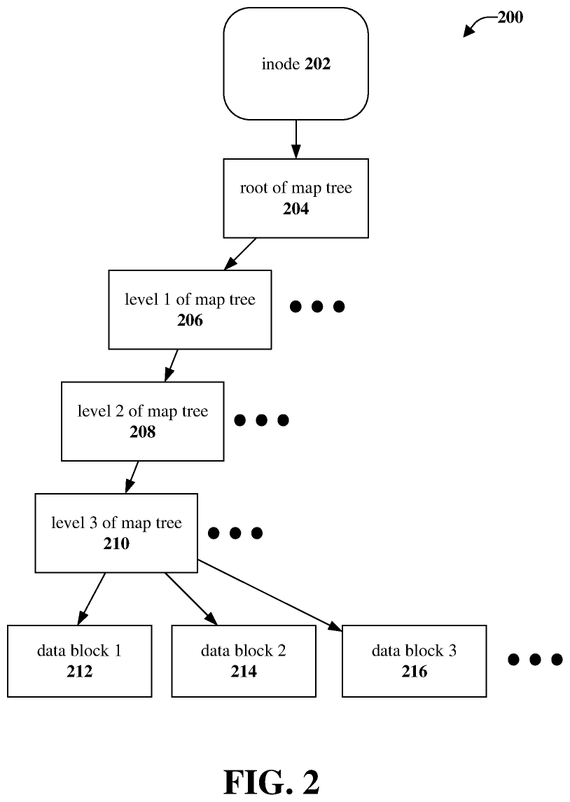

For example, FIG. 2 illustrates an example of the multi-step process to find and access data for a file using a tree structure 200. It is noted that FIG. 2 depicts only the left side of the tree and file. However, before such a deep map tree existed, the file would have many blocks.

The tree structure 200 includes a descriptor for an object, referred to herein as an inode 202. The inode is a data structure that describes a file-system object (e.g., a file, a directory, and so on). For example, some files systems use an inode mechanism that includes a description in the file system of where the data for the file can be located. The inode can also include metadata for the file (e.g., ownership information, time stamps, and so forth).

The file's descriptor (e.g., the inode 202) is read in order to determine where the tree is located on the disk. Although discussed with respect to an inode (e.g., used in a Unix®-style file system), the disclosed embodiments are not limited to an inode and other data structures can be utilized with the disclosed embodiments.

There are different ways of referring to the data on disk from the inode. Some file systems (e.g., original Unix® file system) include the addresses of the first few blocks of the file in the inode and then use an indirection block and a double and triple indirection block beyond that, such that there is a list of block addresses in the inode with which the first portion of the file (sometimes 24 KB to 96 KB) is located, and indirection beyond that point.

Some existing file systems generally use some type of tree structure. Within the inode there will be a pointer to a B-tree, which is indexed by the offset within the file and refers to where the data can be located on the disk. If that B-tree is small enough, then it will be often compacted and put in the inode, sometimes in a different format. In this type of tree structure to find out where a block is, the levels of the tree are traversed, where each level is an index . When attempting to arrive at the first block, a top level index block is read to determine a next block that contains information for the first part of the file. Then, another step down is taken to the next level of the index and can determine a next block that contains the index for the beginning of the file again. Traversal (or reading) of the tree continues through the tree structure, so each level in the index points to a more granular index below it until arriving at the bottom of the tree that has a pointer to where the data is on disk. Thus, if there is a moderately large file, then that tree will have multiple levels and to get to the first block every level of the index has to be read until arriving at the bottom of the tree, at which point it can be determined where the first blocks in the file can be located.

In further detail, below the inode 202, in the tree structure 200, is the root node 204 of the map tree for the object. The root node 204 of the B-tree is read from the disk. By reading one node at a time from the disk, the process descends, in order, through levels of the map tree. The levels of the map tree are illustrated as a first level 206 (e.g., level 1 of the map tree), a second level 208 (e.g., level 2 of the map tree), and a third level 210 (e.g., level 3 of the map tree). Three levels are illustrated and described for purposes of simplicity and, according to various implementations, there can be a different quantity of levels in the map tree (as indicated by the ellipses).

As noted, the nodes are read, in order, through the levels of the map tree (e.g., first level 206, second level 208, third level 210, and so on), until the first leaf node (containing pointers to file data) has been read. In the example of FIG. 2, the first leaf node is below the third level 210, which points to file data location(s). The file data locations are illustrated as a first block data 212 (e.g., block data 1), a second block data 214 (e.g., block data 2), and a third block data 216 (e.g., block data 3). Although three blocks are illustrated and described for purposes of simplicity, a different quantity of block data (e.g., file data) can be utilized with the disclosed embodiments (as indicated by the ellipsis). The pointers from the third level 210 are utilized to read the file data (e.g., the first block data 212, the second block data 214, the third block data 216, and so on).

The multi-step process discussed with respect to FIG. 2 can require a number of input/output (I/O) operations before the first data is available. While this is a general problem, it can be alleviated by simultaneously prefetching file data from disk while earlier data is being returned to the client (e.g., process or remote system) reading the file. However, prefetching does not help at the beginning of the file, which will incur the full latency of reading the tree before any data can be returned. For small files, a common optimization is to include the entire tree in the inode, which entirely eliminates reading the tree from disk. However, this does not help for larger files.

In order to open a file and read the first block, or the first few blocks, with the procedure discussed with respect to the map tree 200 of FIG. 2 requires that, in order for the file to be opened, depending on the size of the file, multiple blocks (e.g., 2 or 3 blocks for a smaller file, 4 or 6 blocks (or more) for a larger file) have to be read in order to determine where the data for the first block(s) is located. Each block in the chain of the tree map is dependent on one another such that the blocks cannot be read in parallel. Thus, the first block of level 1 index has to be read to determine the location of the level 2 index, and so on. This takes time and introduces latency, which can be more pronounced while performing certain functions such as scanning all files in a group to read embedded metadata (e.g., type of file, group to which the file belongs, and so on) located at the beginning portion of the file. Another function can be, for example, opening images in an internet search program and, in order to output thumbnail images, the beginning of the file has to be read in order to determine the information needed to display the thumbnail image. To read the beginning of the files in these cases (as well as other cases not mentioned), many I/Os are needed.

In contrast, the disclosed embodiments utilize two I/Os in order to obtain the same information at the beginning of the files. Accordingly, the disclosed embodiments embed a number of block references from the beginning of the tree into the inode in the case where the tree is too large to be entirely included. This allows the first portion of the file to be read with low latency. Further, prefetching can be used, as usual, to hide the latency of further reads.

For simplicity of describing the disclosed embodiments, a file system with inode and a tree-structured block map is assumed. However, as will be discussed below, the disclosed embodiments are not limited to a tree structure. The map can be more complex than simply mapping file offsets to disk addresses. For example, some file systems use “protection groups” which not only map file offsets to disk addresses but include checksums for error detection and addresses of redundant blocks for error correction.

Further, for simplicity of describing the disclosed embodiments, it is assumed there is sufficient space in the inode to hold a number of disk addresses. If space is reserved in the inode for an embedded b-tree, that space can be re-purposed in the case where the tree is not embedded. An inode can have a flexible amount of space which is available for different purposes.

The disclosed embodiments can be summarized as embedding sufficient information from the block map. This information can be an exact copy or a list of blocks (and in some implementations, checksums), to read the data at the start of the file, given the inode, without having to first read the block map. This allows the data to be read with lower latency. For example, the first block in the file can be read in one disk access (after the inode is in memory) while using the block map may require 4 or more disk reads.

The exact amount of data mapped through the embodiments described herein can be any amount of data and is not limited. In some implementations, the amount of data mapped can be in the range of around 1 MB to about 64 MB.

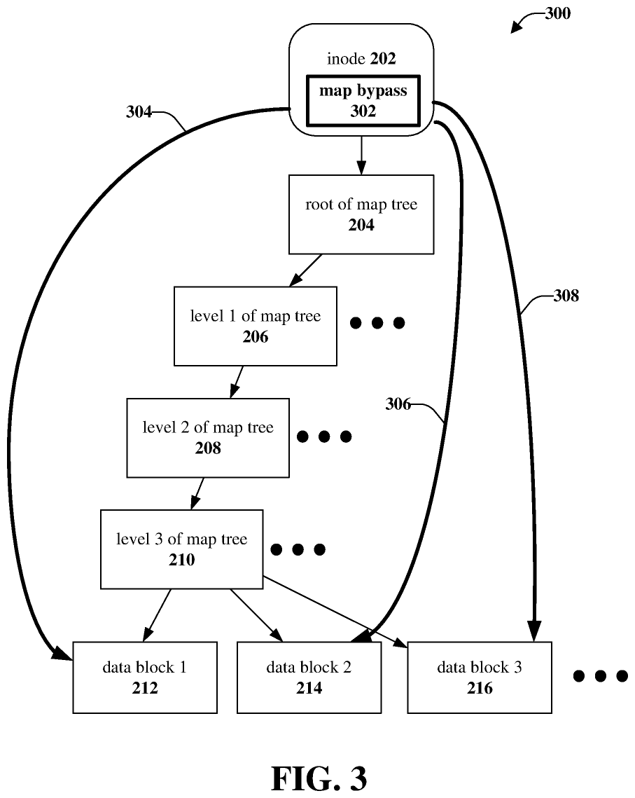

FIG. 3 illustrates an example, non-limiting, schematic representation of a tree structure 300 wherein one or more block addresses are embedded in the inode in accordance with one or more embodiments described herein. Repetitive description of like elements employed in other embodiments described herein is omitted for sake of brevity. It is noted that FIG. 3 depicts only the left side of the tree and file. However, before such a deep map tree existed, the file would have many blocks.

As indicated, the inode 202 can include information that allows for map bypass 302 for one or more data blocks that represent the beginning of an object (e.g., a file, a photograph, thumbnails of photographs, and so on). Thus, when a read request for the object is received, the map bypass 302 can include reading pointers that indicated the respective locations of the first data block 212, the second data block 214, the third data block 216, and so on. Thus, the pointer in the map bypass 302 allows reading of the map tree to be directly bypassed, as indicated at line 304 for the first data block 212; at line 306 for the second data block 214; and at line 308 for the third data block 216. It is noted that although three data blocks are depicted and described, the disclosed embodiments can be utilized with fewer than three data blocks or more than three data blocks.

The map bypass 302 can allow for the direct reading of the first data block 212, the second data block 214, the third data block 216, and so on, at substantially the same time as the tree structure is traversed (as discussed with respect to FIG. 2). Thus, in parallel with the reading of the data blocks using the map bypass 302, traversing the data tree can include reading the root of the map tree 204, which points to level 1 of the map tree (e.g., the first level 206), which points to level 2 of the map tree (e.g., the second level 208), which points to level 3 of the map tree (e.g., the third level 210) and so forth, until respective locations of the portions of the file, after the portions indicated by the map bypass 302 are determined.

According to some implementations, it is possible to embed not a copy, but the beginning of the actual block map, for the file. This could save space, since the map is not stored redundantly in both the inode (e.g., the inode 202) and a separate block map (e.g., the block map 302).

It is noted that the disclosed embodiments are not limited to file systems with a tree-structured block map. For example, a file system which uses indirect blocks can also benefit, as can a file system which uses a list of extents on disk, or a file system which may use multiple block map formats depending on file size.

In cases such as PowerScale®, for example, where the full block map may contain redundancy information, such as multiple blocks each containing a copy of the data, the map bypass need not include such redundancy. In the unlikely event that a data block cannot be read through the bypass, the full map can be used to recover the data. This allows more data to be referenced from a smaller map bypass region (e.g., the map bypass 302).

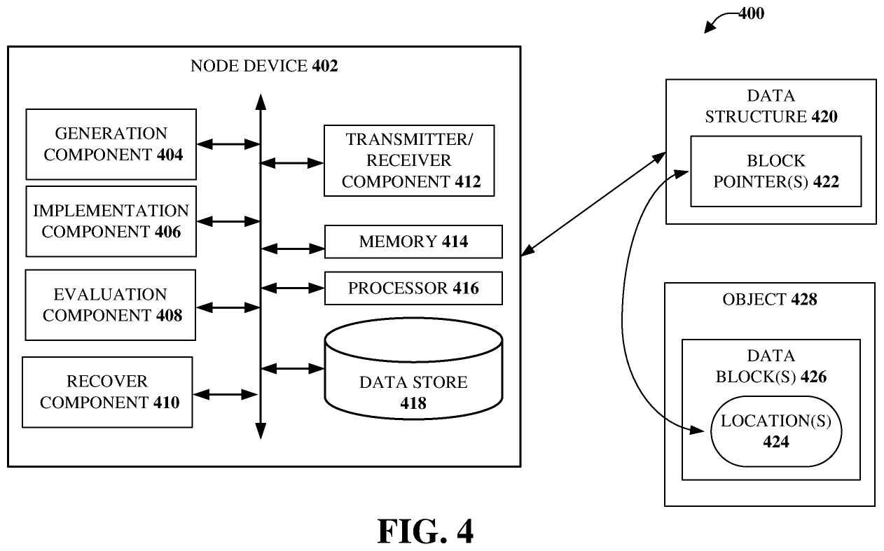

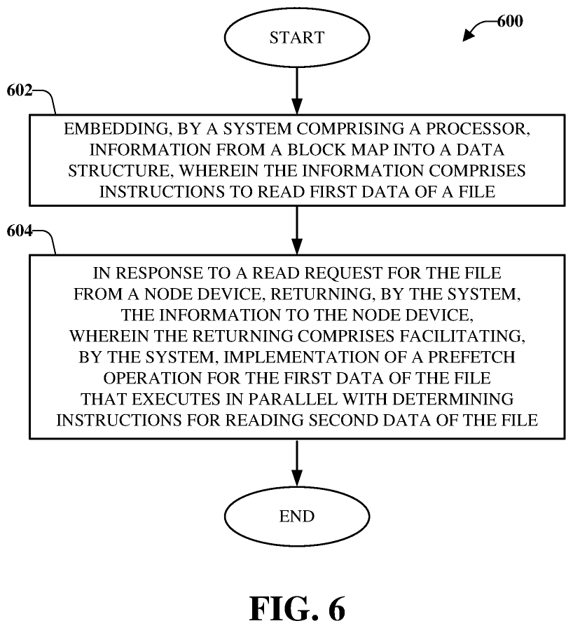

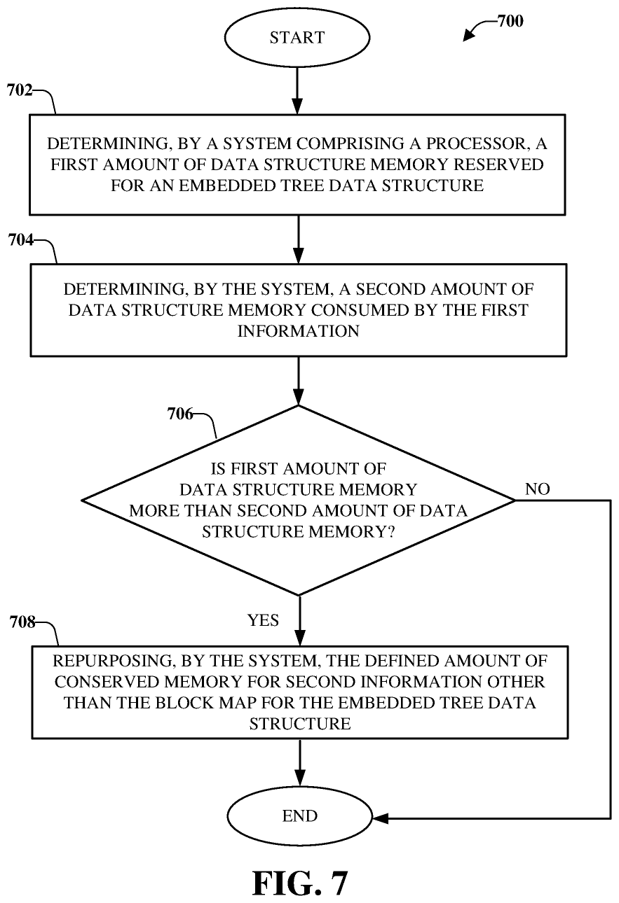

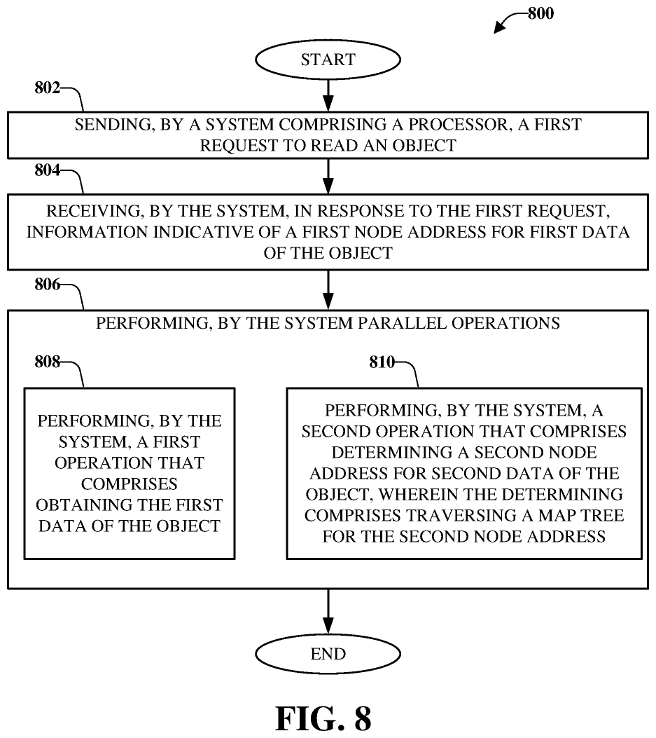

In further detail, FIG. 4 illustrates an example, non-limiting, system 400 that facilitates embedding block references for reducing file access latency in file systems in accordance with one or more embodiments described herein. Repetitive description of like elements employed in other embodiments described herein is omitted for sake of brevity. The system 400 can be configured to perform functions associated with a computer-implemented method 600 of FIG. 6, a computer-implemented method 700 of FIG. 7, a computer-implemented method 800 of FIG. 8, and/or other computer-implemented methods discussed herein.

Aspects of systems (e.g., the system 400 and the like), devices, apparatuses, and/or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the system 400 can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the system 200 can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

The system 400 can include a node device 402, which can be, or can be associated with, a file system. The node device 402 can include a generation component 404, an implementation component 406, an evaluation component 408, a recover component 410, a transmitter/receiver component 412, at least one memory 414, at least one processor 416, and at least one data store 418.

The generation component 404 can populate a data structure 420 with information indicative of one or more block pointers 422 that identifies locations 424 of one or more data blocks 426 of an object 428. The information indicative of the block pointer can be a copy of the first data block from the block map. According to some implementations, the information indicative of the block pointer includes a group of data blocks, including the first data block, from the block map. In some implementations, the information indicative of the block pointer can include respective checksums associated with data blocks of the group of data blocks.

The data structure 420 can be, or can be associated with, a map tree (e.g., the map tree 300 and/or the map bypass 302 of FIG. 3). The block pointers 422 can identify respective locations of the data blocks. The locations can be addresses or other identifying information of storage locations within a storage system.

For example, a first location of a first data block of an object can be identified based on a first address location for the first data block. A second location of a second data block of the object can be identified based on a second address location for the second data block. Subsequent locations of subsequent data blocks of the object can be identified based on subsequent address locations for the subsequent data blocks.

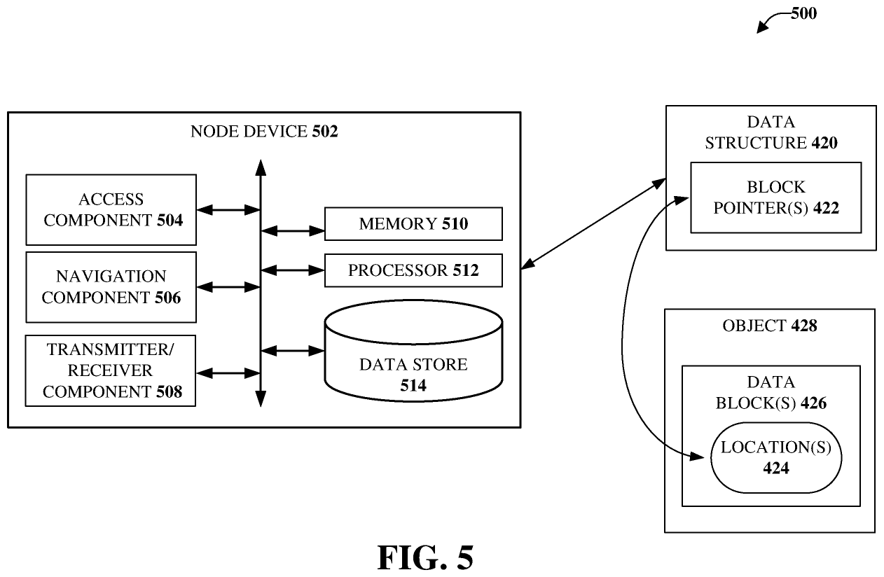

Based on receipt of a read request for the object, the implementation component 406 can enable direct access to the data blocks of the object (without reading the entire map tree) based on the block pointers. The read request can be received, via the transmitter/receiver component 412, from a node (e.g., a node device 502 of FIG. 5) of the storage system or from a different system. The storage system can be, for example, a geographically distributed object storage system, however, the disclosed embodiments are not limited to a distributed object storage system and can be utilized with other storage systems. Further, the object can be a file stored on a file system.

The implementation component 406 can enable access based on bypassing a reading of the data map for access to at least the first data block. According to some implementations, bypassing the reading of the data map can reduce and/or mitigate an amount of latency for reading the object as compared to traversing the block map in order to derive the first location of the first data block. For example, reducing and/or mitigating the amount of latency can include reading the first data block of the object in a single read access, as compared to multiple read accesses for traversing the block map.

Further, at the same time, or substantially the same time, as the implementation component 406 enables the access based on the bypassing, the implementation component 406 can also facilitate reading of the block map for access to a second data block of the object at a same time or substantially the same time as the accessing the first data block. In such a manner, parallel processing is performed such that mitigation and/or reduction of file access latency is achieved.

According to an optional implementation, the evaluation component 408 can determine a first amount of space in the data structure reserved for an embedded tree data structure and a second amount of space in the data structure consumed by the information indicative of the block pointer. If there is more space reserved than the space consumed, there is a defined amount of conserved space. The recover component 410 can repurpose the defined amount of conserved space for information other than the block map for the embedded tree data structure.

The at least one memory 414 can be operatively connected to the at least one processor 416. The at least one memory 414 can store executable instructions and/or computer executable components (e.g., the generation component 404, the implementation component 406, the evaluation component 408, the recover component 410, the transmitter/receiver component 412, and so on) that, when executed by the at least one processor 416 can facilitate performance of operations (e.g., the operations discussed with respect to the various methods and/or systems discussed herein). Further, the at least one processor 416 can be utilized to execute computer executable components (e.g., the generation component 404, the implementation component 406, the evaluation component 408, the recover component 410, the transmitter/receiver component 412, and so on) stored in the at least one memory 414.

For example, the at least one memory 414 can store protocols associated with facilitating the mitigation and/or reduction of file access latency in file systems as discussed herein. Further, the at least one memory 414 can facilitate action to control communication between the system 400 and other node devices, one or more file storage systems, one or more devices, such that the system 400 employs stored protocols and/or algorithms to achieve improved overall performance of file systems as described herein.

It should be appreciated that data stores (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

The at least one processor 416 can facilitate respective analysis of information related to implementing map bypass to mitigate and/or reduce file access latency based on parallel processing that includes reading a first portion of the file and at substantially the same time as (or during the same time as) prefetching is performed for future reads. The at least one processor 416 can be a processor dedicated to analyzing and/or generating information received, a processor that controls one or more components of the system 400, and/or a processor that both analyzes and generates information received and controls one or more components of the system 400.

The transmitter/receiver component 412 can receive one or more requests to access resources and/or objects and/or can return information indicative of file locations or file addresses were first portions of the file are located, without the need to read the entire map tree prior to retrieval of the first portions. The transmitter/receiver component 412 can be configured to transmit to, and/or receive data from, for example, log files, map trees, a defined entity, one or more other nodes, and/or other communication devices. Through the transmitter/receiver component 412, the system 400 can concurrently transmit and receive data, can transmit and receive data at different times, or combinations thereof.

FIG. 5 illustrates an example, non-limiting, system 500 that facilitates performing parallel processing to reduce file access latency in accordance with one or more embodiments described herein. Repetitive description of like elements employed in other embodiments described herein is omitted for sake of brevity.

The system 500 can be configured to perform functions associated with the computer-implemented method 600 of FIG. 6, the computer-implemented method 700 of FIG. 7, the computer-implemented method 800 of FIG. 8, and/or other computer-implemented methods discussed herein.

The system 500 can include a node device 502, which can be associated with, or can be a node device of, a file system. The node device 502 can include an access component 504, a navigation component 506, a transmitter/receiver component 508, at least one memory 510, at least one processor 512, and at least one data store 514.

The node device 502 can transmit, via the transmitter/receiver component 508, a first request to read an object. The request can be transmitted to another node device (e.g., the node device 402) of the file system, or another file system. In response to the request, the node device 502 can receive, via the transmitter/receiver component 508 information indicative of a first node address (e.g., the location 424) for first data (e.g., the first data block 426) of the object (e.g., the object 428).

Further, the node device 502 can perform parallel operations (or overlapping operations) via the access component 504 and the navigation component 506. The access component 504 can perform a first operation that includes obtaining the first data of the object. Thus, the access component 504 can, based on the information indicative of the first node address, directly access the first data without the need to traverse a data map (e.g., the data map 300) first in order to determine the location. At the same time, or substantially the same time, as the access component is directly accessing the first data, the navigation component 506 is performing a second operation. The second operation can include determining a second node address for second data of the object. The determination during the second operation can include traversing (or reading), by the navigation component 506 a map tree for the second node address. The first data of the object is data related to the beginning of the object, and the second data is subsequent data of the object.

The parallel operations performed by the access component 504 and the navigation component 506 can reduce an amount of latency for reading the first data of the object as compared to traversing the map tree in order to derive a first location of a first data block of the object.

The at least one memory 510 can be operatively connected to the at least one processor 512. The at least one memory 510 can store executable instructions and/or computer executable components (e.g., the access component 504, the navigation component 506, the transmitter/receiver component 508, and so on) that, when executed by the at least one processor 512 can facilitate performance of operations (e.g., the operations discussed with respect to the various methods and/or systems discussed herein). Further, the at least one processor 512 can be utilized to execute computer executable components (e.g., the access component 504, the navigation component 506, the transmitter/receiver component 508, and so on) stored in the at least one memory 510.

For example, the at least one memory 510 can store protocols associated with facilitating the mitigation and/or reduction of latency during file access in file systems as discussed herein. Further, the at least one memory 510 can facilitate action to control communication between the system 500 and other node devices, one or more file storage systems, one or more devices, such that the system 500 can employ stored protocols and/or algorithms to achieve improved overall performance of file systems as described herein.

The at least one processor 512 can facilitate respective analysis of information related to opening at least a first block of a file while, in parallel, traversing a map tree to determine locations of other blocks of the file. For example, the at least one processor 512 can read an inode, which includes information indicative of file locations (e.g., file addresses) of where first data blocks of the file are stored wile, in parallel, reading the map tree to determine where second data blocks of the file are stored. The at least one processor 512 can be a processor dedicated to analyzing and/or generating information received, a processor that controls one or more components of the system 500, and/or a processor that both analyzes and generates information received and controls one or more components of the system 500.

The transmitter/receiver component 508 can be configured to transmit to, and/or receive data from, for example, log files, tree maps, a defined entity, one or more other nodes, and/or other communication devices. Through the transmitter/receiver component 508, the system 500 can concurrently transmit and receive data, can transmit and receive data at different times, or combinations thereof.

FIG. 6 illustrates a flow diagram of an example, non-limiting, computer-implemented method 600 that facilitates mitigation of file access latency in accordance with one or more embodiments described herein. The computer-implemented method 500 and/or other methods discussed herein can be implemented by a system comprising a processor and a memory. In an example, the system can be implemented by a node device of a computing system.

The computer-implemented method 600 starts at 602 with embedding, by a system comprising a processor, information from a block map into a data structure (e.g., via the generation component 404). The information includes instructions to locate and read first data of a file.

In response to a read request for the file from a node device (e.g., the node device 502), the system can return, at 604, the information to the node device (e.g., via the implementation component 406). The node device can be a network node device of a cluster of network node devices that are part of a file system. Returning the information can include facilitating, by the system, implementation of a prefetch operation for the first data of the file that executes in parallel with determining instructions for reading second data of the file. The first data of the file is located at a beginning of the file and the second data of the file is subsequent data of the file.

According to some embodiments, facilitating the implementation of the prefetch operation can include causing the node device to bypass traversal of (e.g., the need to read) a tree chain before retrieving the first data of the file. In some embodiments, facilitating the implementation of the prefetch operation can include streaming the first data of the file without incurring a delay associated with data mining the block map for the information. In still further embodiments, facilitating the implementation of the prefetch operation can include instructing the node device to perform a set of reads including a first read to the data structure and a second read to the first data of the file.

FIG. 7 illustrates a flow diagram of an example, non-limiting, computer-implemented method 700 that reuses space originally reserved for an embedded tree data structure in accordance with one or more embodiments described herein. The computer-implemented method 700 and/or other methods discussed herein can be implemented by a system comprising a processor and a memory. In an example, the system can be implemented by a node device of a storage system.

The computer-implemented method 700 starts at 702, when a first amount of data structure memory reserved for an embedded tree data structure is determined. Further, at 704, a second amount of data structure memory consumed by first information can be determined. The first amount of data structure memory reserved less the second amount of data structure memory consumed results in a defined amount of conserved memory (e.g., via a subtraction operation).

At 706, a determination is made whether the first amount of data structure memory is more than the second amount of data structure memory. If not (“NO”), the computer-implemented method 700 ends. However, if the first amount of data structure memory is more than the second amount of data structure memory (“YES”) there is a defined amount of conserved memory. Thus, at 708, the defined amount of conserved memory is repurposed for second information other than the block map for the embedded tree data structure.

FIG. 8 illustrates a flow diagram of an example, non-limiting, computer-implemented method 800 that performs parallel processing to reduce file access latency devices in accordance with one or more embodiments described herein. The computer-implemented method 800 and/or other methods discussed herein can be implemented by a system comprising a processor and a memory. In an example, the system can be implemented by a node device of a file system.

At 802 of the computer-implemented method 800, a first request to read an object is sent (e.g., via the transmitter/receiver component 508). In response to the first request, at 804, information indicative of a first node address for first data of the object is received (e.g., via the transmitter/receiver component 508).

Upon or after the information indicative of the first node address is received, at 806, parallel operations can be performed to open (or read) the object. For example, at 808, a first operation that includes obtaining the first data of the object can be transmitted (e.g., via the access component 504). To obtain the first data of the object, an inode can be accessed and a map bypass can be read. Further, at 810, a second operation that includes determining a second node address for second data of the object can be performed (e.g., via the navigation component 506). Determining the second node address can include traversing a map tree for the second node address. The first data of the object is data related to the beginning of the object, and the second data is subsequent data of the object. The parallel operations can reduce an amount of latency for reading the first data of the object as compared to traversing the map tree in order to derive a first location of a first data block of the object.

Methods that can be implemented in accordance with the disclosed subject matter, will be better appreciated with reference to the flow charts provided herein. While, for purposes of simplicity of explanation, the methods are shown and described as a series of blocks, it is to be understood and appreciated that the disclosed aspects are not limited by the number or order of blocks, as some blocks can occur in different orders and/or at substantially the same time with other blocks from what is depicted and described herein. Moreover, not all illustrated blocks can be required to implement the disclosed methods. It is to be appreciated that the functionality associated with the blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

As used herein, the term “storage device,” “first storage device,” “second storage device,” “storage cluster nodes,” “storage system,” and the like (e.g., node device), can include, for example, private or public cloud computing systems for storing data as well as systems for storing data comprising virtual infrastructure and those not comprising virtual infrastructure. The term “I/O request” (or simply “I/O”) can refer to a request to read and/or write data.

The term “cloud” as used herein can refer to a cluster of nodes (e.g., set of network servers), for example, within an object storage system, that are communicatively and/or operatively coupled to one another, and that host a set of applications utilized for servicing user requests. In general, the cloud computing resources can communicate with user devices via most any wired and/or wireless communication network to provide access to services that are based in the cloud and not stored locally (e.g., on the user device). A typical cloud-computing environment can include multiple layers, aggregated together, that interact with one another to provide resources for end-users.

Further, the term “storage device” can refer to any Non-Volatile Memory (NVM) device, including Hard Disk Drives (HDDs), flash devices (e.g., NAND flash devices), and next generation NVM devices, any of which can be accessed locally and/or remotely (e.g., via a Storage Attached Network (SAN)). In some embodiments, the term “storage device” can also refer to a storage array comprising one or more storage devices. In various embodiments, the term “object” refers to an arbitrary-sized collection of user data that can be stored across one or more storage devices and accessed using I/O requests.

Further, a storage cluster can include one or more storage devices. For example, a storage system can include one or more clients in communication with a storage cluster via a network. The network can include various types of communication networks or combinations thereof including, but not limited to, networks using protocols such as Ethernet, Internet Small Computer System Interface (iSCSI), Fibre Channel (FC), and/or wireless protocols. The clients can include user applications, application servers, data management tools, and/or testing systems.

As utilized herein an “entity,” “client,” “user,” and/or “application” can refer to any system or person that can send I/O requests to a storage system. For example, an entity, can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

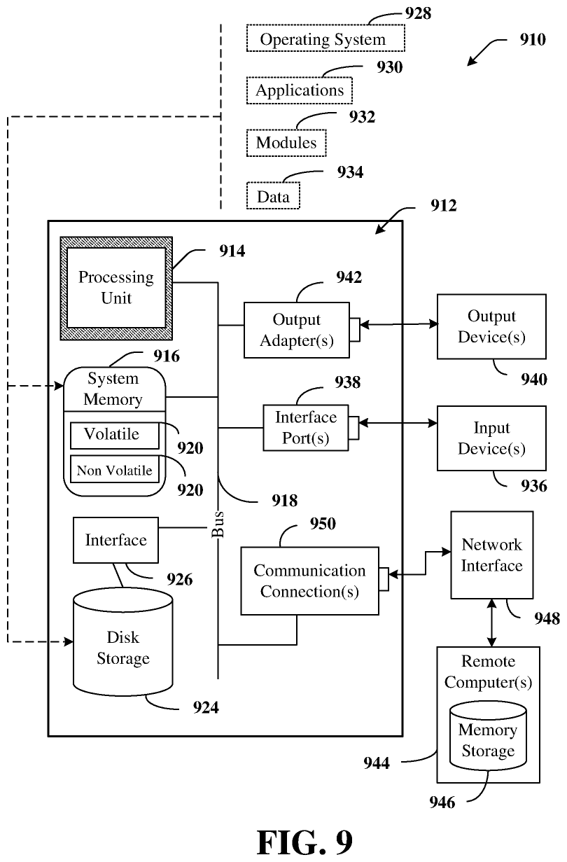

In order to provide a context for the various aspects of the disclosed subject matter, FIG. 9 as well as the following discussion are intended to provide a brief, general description of a suitable environment in which the various aspects of the disclosed subject matter can be implemented.

With reference to FIG. 9, an example environment 910 for implementing various aspects of the aforementioned subject matter comprises a computer 912. The computer 912 comprises a processing unit 914, a system memory 916, and a system bus 918. The system bus 918 couples system components including, but not limited to, the system memory 916 to the processing unit 914. The processing unit 914 can be any of various available processors. Multi-core microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 comprises volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can comprise read only memory (ROM), programmable ROM (PROM), electrically programmable ROM (EPROM), electrically erasable PROM (EEPROM), or flash memory. Volatile memory 920 comprises random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also comprises removable/non-removable, volatile/non-volatile computer storage media. FIG. 9 illustrates, for example a disk storage 924. Disk storage 924 comprises, but is not limited to, devices like a magnetic disk drive, floppy disk drive, tape drive, Jaz drive, Zip drive, LS-100 drive, flash memory card, or memory stick. In addition, disk storage 924 can comprise storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 924 to the system bus 918, a removable or non-removable interface is typically used such as interface 926.

It is to be appreciated that FIG. 9 describes software that acts as an intermediary between users and the basic computer resources described in suitable operating environment 910. Such software comprises an operating system 928. Operating system 928, which can be stored on disk storage 924, acts to control and allocate resources of the computer 912. System applications 930 take advantage of the management of resources by operating system 928 through program modules 932 and program data 934 stored either in system memory 916 or on disk storage 924. It is to be appreciated that one or more embodiments of the subject disclosure can be implemented with various operating systems or combinations of operating systems.

A user enters commands or information into the computer 912 through input device(s) 936. Input devices 936 comprise, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 comprise, for example, a serial port, a parallel port, a game port, and a universal serial bus (USB). Output device(s) 940 use some of the same type of ports as input device(s) 936. Thus, for example, a USB port can be used to provide input to computer 912, and to output information from computer 912 to an output device 940. Output adapters 942 are provided to illustrate that there are some output devices 940 like monitors, speakers, and printers, among other output devices 940, which require special adapters. The output adapters 942 comprise, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically comprises many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies comprise Fiber Distributed Data Interface (FDDI), Copper Distributed Data Interface (CDDI), Ethernet/IEEE 802.3, Token Ring/IEEE 802.5, and the like. WAN technologies comprise, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the system bus 918. While communication connection 950 is shown for illustrative clarity inside computer 912, it can also be external to computer 912. The hardware/software necessary for connection to the network interface 948 comprises, for exemplary purposes only, internal and external technologies such as, modems including regular telephone grade modems, cable modems and DSL modems, ISDN adapters, and Ethernet cards.

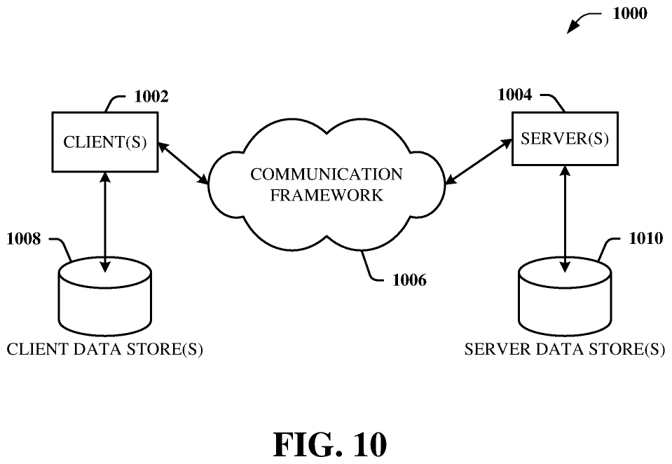

FIG. 10 is a schematic block diagram of a sample computing environment 1000 with which the disclosed subject matter can interact. The sample computing environment 1000 includes one or more client(s) 1002. The client(s) 1002 can be hardware and/or software (e.g., threads, processes, computing devices). The sample computing environment 1000 also includes one or more server(s) 1004. The server(s) 1004 can also be hardware and/or software (e.g., threads, processes, computing devices). The servers 1004 can house threads to perform transformations by employing one or more embodiments as described herein, for example. One possible communication between a client 1002 and servers 1004 can be in the form of a data packet adapted to be transmitted between two or more computer processes. The sample computing environment 1000 includes a communication framework 1006 that can be employed to facilitate communications between the client(s) 1002 and the server(s) 1004. The client(s) 1002 are operably connected to one or more client data store(s) 1008 that can be employed to store information local to the client(s) 1002. Similarly, the server(s) 1004 are operably connected to one or more server data store(s) 1010 that can be employed to store information local to the servers 1004.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. Yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable storage media can comprise, but are not limited to, radon access memory (RAM), read only memory (ROM), electrically erasable programmable read only memory (EEPROM), flash memory or other memory technology, solid state drive (SSD) or other solid-state storage technology, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

Disclosed embodiments and/or aspects should neither be presumed to be exclusive of other disclosed embodiments and/or aspects, nor should a device and/or structure be presumed to be exclusive to its depicted element in an example embodiment or embodiments of this disclosure, unless where clear from context to the contrary. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of elements (or embodiments) into a single device achieving aggregate functionality, where suitable, or distribution of functionality of a single device into multiple device, where suitable. In addition, incorporation, combination or modification of devices or elements (e.g., components) depicted herein or modified as stated above with devices, structures, or subsets thereof not explicitly depicted herein but known in the art or made evident to one with ordinary skill in the art through the context disclosed herein are also considered within the scope of the present disclosure.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs., where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable instructions that, when executed by the processor, facilitate performance of operations, comprising:
populating a data structure of the system with information indicative of a block pointer that identifies a first location of a first data block of an object, wherein the first location is a location within a storage system; and
based on a receipt of a read request for the object, enabling access to the first data block of the object based on the block pointer, wherein the enabling comprises bypassing a reading of a block map for access to the first data block.

2. The system of claim 1, wherein the operations further comprise:
facilitating reading the block map for access to a second data block of the object at a same time or substantially the same time as the accessing the first data block.

3. The system of claim 1, wherein the information indicative of the block pointer is a copy of the first data block from the block map.

4. The system of claim 1, wherein the information indicative of the block pointer comprises a group of data blocks, including the first data block, from the block map.

5. The system of claim 4 wherein the information indicative of the block pointer comprise respective checksums associated with data blocks of the group of data blocks.

6. The system of claim 1, wherein the information indicative of the block pointer is first information, and wherein the operations further comprise:
determining a first amount of space in the data structure reserved for an embedded tree data structure, and a second amount of space in the data structure consumed by the first information, resulting in a defined amount of conserved space; and
repurposing the defined amount of conserved space for second information other than the block map for the embedded tree data structure.

7. The system of claim 1, wherein the bypassing comprises reducing an amount of latency for reading the object as compared to traversing the block map in order to derive the first location of the first data block.

8. The system of claim 7, wherein the reducing the amount of latency comprises reading the first data block of the object in a single read access, as compared to multiple read accesses for traversing the block map.

9. The system of claim 1, wherein the storage system is a geographically distributed object storage system.

10. The system of claim 1, wherein the object is a file stored on a file system.

11. A method, comprising:
embedding, by a system comprising a processor, information from a block map into a data structure, wherein the information comprise instructions to read first data of a file; and
in response to a read request for the file from a node device, returning, by the system, the information to the node device, wherein the returning comprises facilitating implementation of a prefetch operation for the first data of the file that executes in parallel with determining instructions for reading second data of the file.

12. The method of claim 11, wherein the facilitating the implementation of the prefetch operation comprises causing the node device to bypass traversal of a tree chain before retrieving the first data of the file.

13. The method of claim 11, wherein the facilitating the implementation of the prefetch operation comprises streaming the first data of the file without incurring a delay associated with data mining the block map for the information.

14. The method of claim 11, wherein the facilitating the implementation of the prefetch operation comprises instructing the node device to perform a set of reads comprising a first read to the data structure and a second read to the first data of the file.

15. The method of claim 11, wherein the information from the block map is first information, and wherein the method further comprises:
determining, by the system, a first amount of data structure memory reserved for an embedded tree data structure, and a second amount of data structure memory consumed by the first information, resulting in a defined amount of conserved memory; and
repurposing, by the system, the defined amount of conserved memory for second information other than the block map for the embedded tree data structure.

16. The method of claim 11, wherein the first data of the file is located at a beginning of the file, and wherein the second data of the file is subsequent data of the file.

17. The method of claim 11, wherein the node device is a network node device of a cluster of network node devices.

18. A non-transitory machine-readable medium, comprising executable instructions that, when executed by a processor, facilitate performance of operations, comprising:
sending a first request to read an object;
receiving, in response to the first request, information indicative of a first node address for first data of the object; and
performing parallel operations comprising performing:
a first operation that comprises obtaining the first data of the object; and
a second operation that comprises determining a second node address for second data of the object, wherein the determining comprises traversing a map tree for the second node address.

19. The non-transitory machine-readable medium of claim 18, wherein the parallel operations reduce an amount of latency for reading the first data of the object as compared to traversing the map tree in order to derive a first location of a first data block of the object.

20. The non-transitory machine-readable medium of claim 18, wherein the first data of the object is data related to the beginning of the object, and wherein the second data is subsequent data of the object.
